(19) United States
(12) Patent Application Publication
(10) Pub. No.: US 2015/0041688 A1
(43) Pub. Date: Feb. 12, 2015

(54) ELECTRO-HYDRAULIC SYSTEM FOR DRIVING LARGE-SCALE ROTARY MOTION VALVE SUPPLIED BY SOLAR LOW-CAPACITY POWER

(71) Applicant: Baojun LIU, (US)

(72) Inventors: Baojun Liu, Liaoning (CN); Xueming Zheng, Liaoning (CN); Xianshuang Shun, Liaoning (CN); Guanhua Liu, Liaoning (CN); Li Lei, Liaoning (CN); Qiang Nie, Liaoning (CN); Jinshan Xu, Liaoning (CN)

(21) Appl. No.: 14/388,239

(22) PCT Filed: Apr. 19, 2013
(86) PCT No.: PCT/CN2013/074388

§ 371 Date: Sep. 25, 2014

(30) Foreign Application Priority Data
Apr. 23, 2012 (CN) 201210119012.7

(51) Int. Cl. F16K 31/163; F16K 31/54; F16K 31/42

(52) U.S. Cl. CPC F16K 31/1635; F16K 31/42; F16K 31/54
USPC 251/25

(57) ABSTRACT

An electro-hydraulic system for driving a large-scale rotary motion valve supplied by a solar low-capacity power. A step motor (2) and an oil pump (3) are in turn driven by a low-capacity solar power supply (1). An oil tank (5), the oil pump, a check valve (6), a T-connector (7) and a liquid accumulator (10) are in turn arranged on an oil storage pipeline (4). An oil inlet pipeline (16) is connected to the rest of the ports of the T-connector. An oil inlet of a three-position four-way reversing solenoid valve (12) is connected to the oil inlet pipeline. Two ends of an oil return pipeline are connected to an oil return port of the reversing valve and an oil return port of the oil tank, respectively. Each of two oil outlets of the reversing valve is respectively connected to an oil port of a single-chamber cylinder via a pipeline. The outer ends of the piston rods of cylinders A and B are rigidly connected together to form one piston rod (134). A linear-to-rotary transition mechanism is provided between the piston rod (134) and a spool (19) of the rotary motion valve. Since the low-capacity solar power supply is adopted in the system, the equipment cost, the operation cost and the maintenance cost of the system are reduced, and the input-output ratio of the system is increased.

### BACKGROUND OF THE INVENTION

This invention refers to a type of Electro-hydraulic controlled driving system, specifically defined as t Miniwatt Solar Power supplied Electro-hydraulic System driving large rotary valve.

The large rotary valves mentioned in this invention refers to valves, such as ball valve, butterfly valve, used in field oil or gas pipelines. The torque that drives the rotary valve is 500-110000N·m, equivalent to power output range of 500˜4000 W. Driving such large valves often requires large AC power supply, and the AC power supply and AC motor requires the starting current. Besides all above, to utilize AC power supply in the field needs to related electric transmission and transformation equipments, all these will result the system's equipment, motion and maintenance costs to dramatically go up. If the large solar power supply is utilized to meet the system requirement this will also result the system's equipment cost to go up.

### BRIEF SUMMARY OF THE INVENTION

In order to solve the above technical issues, this invention's purpose is to offer a Miniwatt Solar Power supplied Electro-hydraulic System driving large rotary valve.

As the valve used in the field oil or gas pipeline is not required moving frequently and solar power is available in the field locations, so the concept of this invention is: to utilize the miniwatt solar power for power supply and convert the solar power electrical energy to hydraulic energy, and continually store and accumulate this energy. When the valve is required to move, the stored hydraulic energy will be converted to mechanical energy and released to drive the rotary valve.

The technical solution of this invention concept is: the miniwatt solar power supply (24VDC, 200˜500 W) drives the stepper motor and oil pump in order, the oil storage pipeline has oil tank, oil pump, check valve, tee joint and hydraulic accumulator (hereinafter identified as accumulator), the remaining port of tee joint connects with the oil pumping pipeline, three-position four-way directional solenoid valve's (hereinafter identified as directional valve) oil inlet connects with the oil pumping pipeline, the oil returning pipeline's two ends are respectively connected with the directional valve's and oil tank's oil returning ports, the two oil outlets (A and B)of directional valve connect with the single chamber oil cylinder's (hereinafter identified as cylinder) oil ports, A and B cylinders' piston rods are connected by becoming one rigid piston rod. The piston rod is connected with the valve rod utilizing a linear motion to rotation motion conversion mechanism.

When the valve is not moving, the oil pump driven by the miniwatt solar power supply and stepper motor continually pumps the oil from the oil tank to the accumulator through oil storage pipeline, converting solar energy to hydraulic energy and accumulate constantly.

When the valve needs to move towards the forward direction, one side of the directional valve's solenoid is taking action. As the oil inlet of the directional valve connect with A oil outlet, the oil return port connect with B oil outlet, the hydraulic oil inside the accumulator enters A cylinder through tee joint and directional valve' oil inlet and A oil outlet, drives the piston rod to move to the forward direction, through a linear motion to rotation motion conversion mechanism to drive the rotary valve shaft rotate in the forward direction. In the meantime, oil in B cylinder flows back to oil tank through directional valve's B oil outlet and oil return port. When the valve needs to move towards the backward direction, the other side of the directional valve's solenoid is taking action, the oil inlet of the directional valve connects with B oil outlet, the oil return port connects with A oil outlet, the hydraulic oil inside the accumulator enters B cylinder through tee joint and directional valve' oil inlet and B oil outlet, drives the piston rod to move to the backward direction, through a linear motion to rotation motion conversion mechanism to drive the rotary valve shaft rotate in the reversing direction, to drive the rotary valve moving to the reversing direction. In the meantime, oil in A cylinder flows back to oil tank through directional valve's A oil outlet and oil return port.

In comparison with the current technology, The positive effects of this invention is: to utilize the miniwatt solar power supply and stepper motor, no normal starting current required. The selected power supply does not need to be oversized, which greatly reduces the system's equipment, motion and maintenance costs and improves the system input-output ratio, and becomes the actual environmental-friendly system.

### BRIEF DESCRIPTION OF THE DRAWINGS

FIG. 1 is the invention schematic diagram when the linear motion to rotation motion conversion mechanism is rack and pinion.

FIG. 2 is the invention schematic diagram when the linear motion to rotation motion conversion mechanism is scotch yoke.

### DETAILED DESCRIPTION OF THE INVENTION

Implementation example one: the linear motion to rotation motion conversion mechanism is rack and pinion.

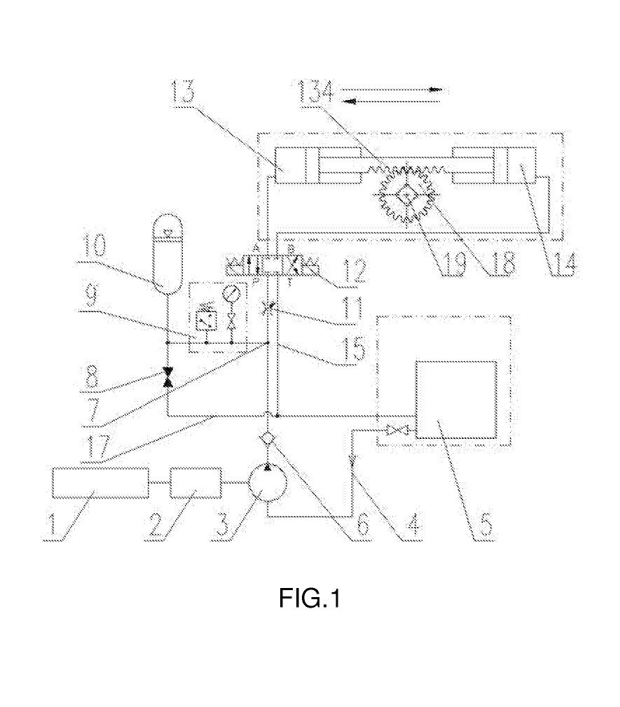

See FIG. 1. The 200˜500 W, 24VDC miniwatt solar power supply 1 drives stepper motor 2 and oil pump 3 in sequence. The oil storage pipeline 4 includes oil tank 5, oil pump, check valve 6, tee joint 7 and accumulator 10. The remaining port of tee joint connects with oil pumping pipeline 16; directional valve 12 oil inlet that is port P connects with oil pumping pipeline, the two ends of oil return pipeline 15 connect with directional valve's oil return port T and oil return port of the oil tank, the directional valve's A port connects with A cylinder 13 oil port, the directional valve's B port connects with B cylinder 14 oil port. A cylinder's and B cylinder's piston rod are connected by becoming one piston rod 134. The linear motion to rotation motion conversion mechanism between piston rod and rotary valve shaft is a rack and pinion design, one side of the piston rod 134 is rack shaped which gears pinion 18. The pinion and rotary valve shaft 19 are connected by keyway and key. There are pressure indication and monitoring devices 9 in the oil pumping pipeline between tee joint and accumulator. The pressure indication and monitoring devices include a pressure gauge which indicates the pressure within the accumulator and a pressure switch that controls the stepper motor. When the pressure within the accumulator is higher than the limit value, the pressure switch turns off the stepper motor. The evacuation pipeline is set between the oil tank's oil returning port and the accumulator 17. A on-off valve 8 is located at the evacuation pipeline that discharges the oil in the accumulator to oil tank during maintenance process. The speed regulator 11 is at the oil pumping pipeline 16.

When the angular moving valve is not in action, the oil pump is driven by the miniwatt solar power supply and stepper motor, continually pumping the oil from the oil tank to the accumulator through oil storage pipeline, converting the electrical energy to hydraulic energy and accumulate.

When the rotary valve needs to close, one side of the directional valve's solenoid is taking action, the directional valve P port is connected with A port, the T port is connected with B oil outlet, the hydraulic oil inside the accumulator enters A cylinder through tee joint, directional valve P port and A port, driving the piston rod to move to the right direction. The pinion 18 of the linear motion to rotation motion conversion mechanism drives gear and rotary valve shaft to rotate clockwise and the rotary valve closes. In the meantime, oil in B cylinder flows back to oil tank through directional valve B port and T port. When the valve needs to open, the other side of the directional valve's solenoid is taking action, directional valve P port is connected with B port, the T port is connected with A, the hydraulic oil inside the accumulator enters B cylinder through tee joint, directional valve P port and B port, driving the piston rod to move to the left. The pinion 18 of the linear motion to rotation motion conversion mechanism drives gear and rotary valve shaft to valve opening position. In the meantime, oil in A cylinder flows back to oil tank through directional valve A port and T port.

Implementation example two: the linear motion to rotation motion conversion mechanism is scotch yoke.

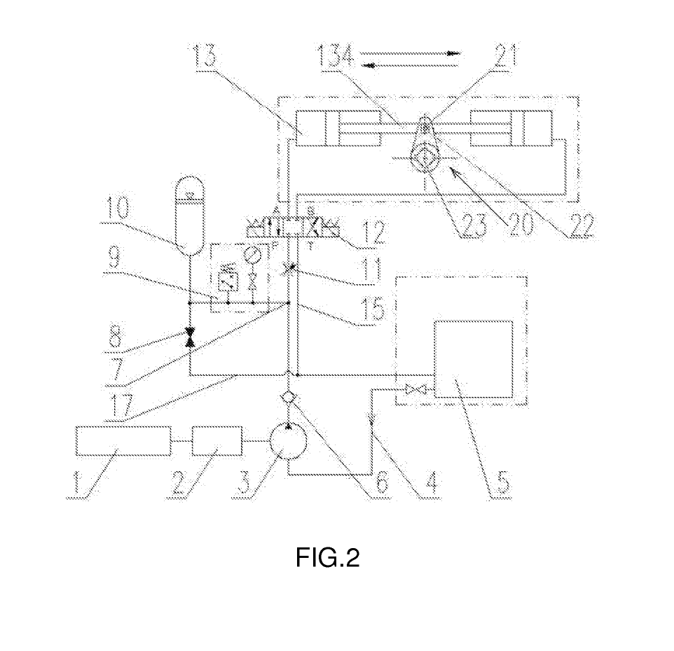

See FIG. 2. The difference between the previous implementation example 1 is that the linear motion to rotation motion conversion mechanism is scotch yoke 20. The scotch yoke is a force—torque conversion mechanism as defined in CN101210633A. The detail is fixing a sliding block 21 at piston rod 134, the sliding block is in the slide way 22 of the scotch yoke connected with rotary valve shaft, i.e., the lower end of the scotch yoke is shaft sleeve which is connected with rotary valve shaft 23 by keyway and key. Remaining process are the same as implementation example one.

When the piston rod moves to the right, the sliding block pushes the scotch yoke swinging to the right, the rotary valve shaft rotates to the right to drive the rotary valve to close. When the piston rod moves to the left, the sliding block pushes the scotch yoke swinging to the left, the rotary valve shaft rotates to the left to drive the rotary valve to open. Remaining process are the same as implementation example one.

What is claimed is:

1. Miniwatt Solar Power Supplied Electro-hydraulic System driving large rotary valve features the following: Miniwatt solar power drives the stepper motor and oil pump in order; the oil storage pipeline has oil tank, oil pump, check valve, tee joint and liquid accumulator; the remaining port of tee joint connects with the oil pumping pipeline, three-position four-way directional solenoid valve's oil inlet connects with the oil pumping pipeline, the oil returning pipeline's two ends are respectively connected with the directional valve's and oil tank's oil returning ports, the two oil outlets of directional valve connected with the single chamber oil cylinder's oil ports; A and B cylinders' piston rods are connected by becoming one rigid piston rod; the piston rod is connected with the valve rod utilizing a linear motion to rotation motion conversion mechanism.

2. The Miniwatt Solar Power Supplied Electro-hydraulic System driving large rotary valve according to claim 1, wherein the linear motion to rotation motion conversion mechanism is the one of rack and pinion, one side of the piston rod is rack shaped gearing a pinion, the pinion is connected with valve rod by keyway and key.

3. The Miniwatt Solar Power Supplied Electro-hydraulic System driving large rotary valve according to claim 1, wherein the linear motion to rotation motion conversion mechanism is a scotch yoke, of which a sliding block fixed to the piston rod moves in the yoke slide way, the scotch yoke is connected with rotary valve shaft, i.e., the lower end of the scotch yoke is shaft sleeve which is connected with rotary valve shaft by keyway and key.

4. The Miniwatt Solar Power Supplied Electro-hydraulic System driving large rotary valve according to any one of claims 1-3, wherein between the tee joint's and accumulator's oil pumping pipeline there are pressure indication and monitoring devices, including a pressure gauge which indicates the pressure within the accumulator and a pressure switch that controls the stepper motor; the evacuation pipeline is set between the oil tank's oil returning port and the accumulator; a on-off valve is at the evacuation pipeline and a speed regulator is at the oil pumping pipeline.
